(19) United States
(12) Patent Application Publication
(10) Pub. No.: US 2010/0303621 A1
(43) Pub. Date: Dec. 2, 2010

(54) CONSTRUCTION OF AN IN-PIPE TURBINE

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/745,549

(22) PCT Filed: Nov. 30, 2008
(86) PCT No.: PCT/IB08/55016

§ 371 Date: May 31, 2010

Related U.S. Application Data
(60) Provisional application No. 60/991,789, filed on Dec. 3, 2007.
(60) Provisional application No. 61/017,816, filed on Dec. 31, 2007.
(60) Provisional application No. 61/037,011, filed on Mar. 17, 2008.
(60) Provisional application No. 61/058,235, filed on Jun. 3, 2008.

(51) Int. Cl. F04D 5/00; H02K 7/18; F04D 29/38; B23P 15/04

(52) U.S. Cl. 415/224; 290/52; 416/243; 29/889.2

(57) ABSTRACT

Devices and methods of manufacturing important parts of a Benkatina Turbine are described.

This patent application claims the benefit of U.S. Provisional Patent Application No. 60/991,789, Wind, Wave, and Water Renewable Energy Elaborations, filed Dec. 3, 2007; 61/017,816, Hydro Turbines, Portable Wind, Waves, and Magnets, filed Dec. 31, 2007; 61/037,011, Provisional 3-08 Slanted roof wind turbine Sewage turbine system and buoys, filed Mar. 17, 2008; 61/058,235, Provisional 6-08: Improvements to renewable energy devices, Jun. 3, 2008.

### FIELD AND BACKGROUND OF THE INVENTION

The present invention relates to a Benkatina Turbine and how to construct it. A Benkatina Turbine is an in-pipe turbine fitting inside a main and side chamber. It was previously described in terms of its overall shape in PCT application IL07/000770. This patent application describes novel features of that turbine type and their construction.

### BRIEF DESCRIPTION OF THE DRAWINGS

The invention is herein described, by way of example only, with reference to the accompanying drawings, wherein:

FIG. 1 is a diagram of Benkatina nozzles and blade arrangements.

FIG. 2 is a diagram of how a peripheral nozzle would work.

FIG. 3 is a photo of actual nozzles.

FIG. 4 is a diagram of a magnetic coupling used with a Benkatina turbine.

FIG. 5 is a diagram of a Benkatina turbine with a built-in coil.

FIG. 6 is a diagram of a turbine with two sides.

FIG. 7 is a diagram of a crown and blades.

FIG. 8 is a diagram of an open top turbine.

FIG. 9 is a diagram of construction of the casing.

### DESCRIPTION OF THE PREFERRED EMBODIMENTS

The present invention relates to ways of building a Benkatina turbine.

The principles and operation of a Benkatina turbine according to the present invention may be better understood with reference to the drawings and the accompanying description.

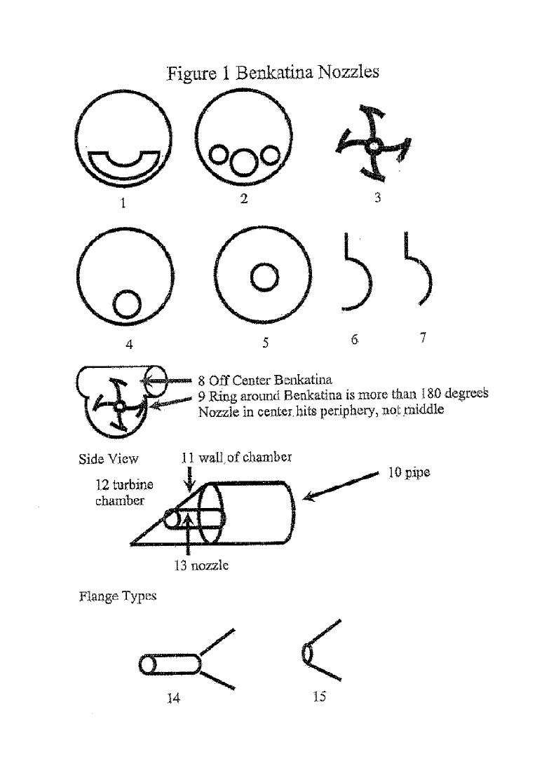

Referring now to the drawings, FIG. 1 illustrates Benkatina nozzles and blade arrangements. The use of different nozzles and flange types with a Benkatina turbine is hereby introduced, as well as their use in combination with matching blades. In the ideal embodiment, blades shaped in a cup or indentation to match the location and size of the nozzle output are used. For example, a banana shaped nozzle (1 or 2) may match a banana-shaped indentation in the periphery of the blades (3). In another embodiment, a peripheral circular nozzle (4) may be used, and that can also match a blade such as (3). The method of using such a shape could be in a situation where the flow didn't fill the pipe in order to enable the flow velocity to hit the blades more effectively for that flow pattern. A central nozzle hole (5) can match blade shapes (6) and (7). Blade (7) is distinguished by having part of the blade periphery cut off so that it can drain out the water more easily after it has hit the cup. In one embodiment, the inlet pipe's nozzle is located in the center of the inlet (for less turbulent flow), but the nozzle's stream (8) enters the turbine chamber at the periphery of the Benkatina blades; this is referred to in the picture as an off-center Benkatina turbine, because the turbine is centered so that its midline is farther removed from the pipe and the surrounding case is more than 180 degrees. One way of shaping the nozzle piece (13) is to shape the portion facing the interior of the turbine (12) away from the pipe (10) so that the nozzle surface (11) has a shape that matches the circular pattern of the walls of the main chamber of the turbine turbine. Flange types for the nozzle may comprise at least one hole at the end of the pipe (14) or at least one hole with an area that narrows down into the hole within the entry pipe (15).

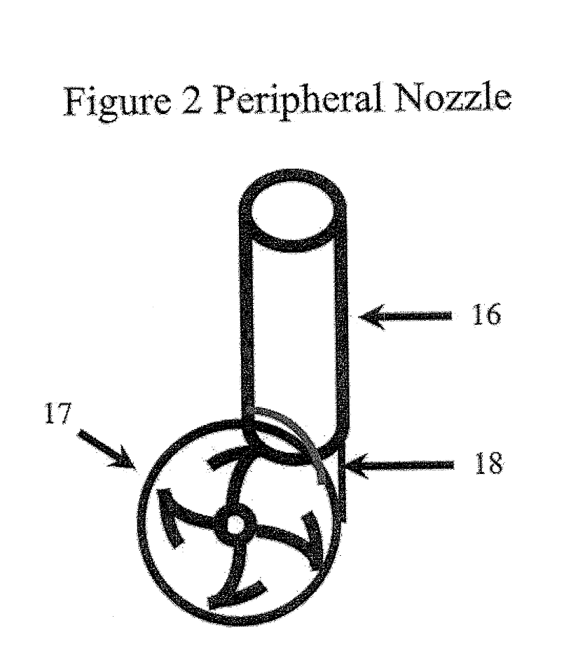

FIG. 2 is a diagram of how a peripheral nozzle would work. The pipe (16) is connected to the turbine (17). The nozzle (18) is peripheral, like (1, 2, 4) in FIG. 1. This configuration would be useful in a situation of higher torque.

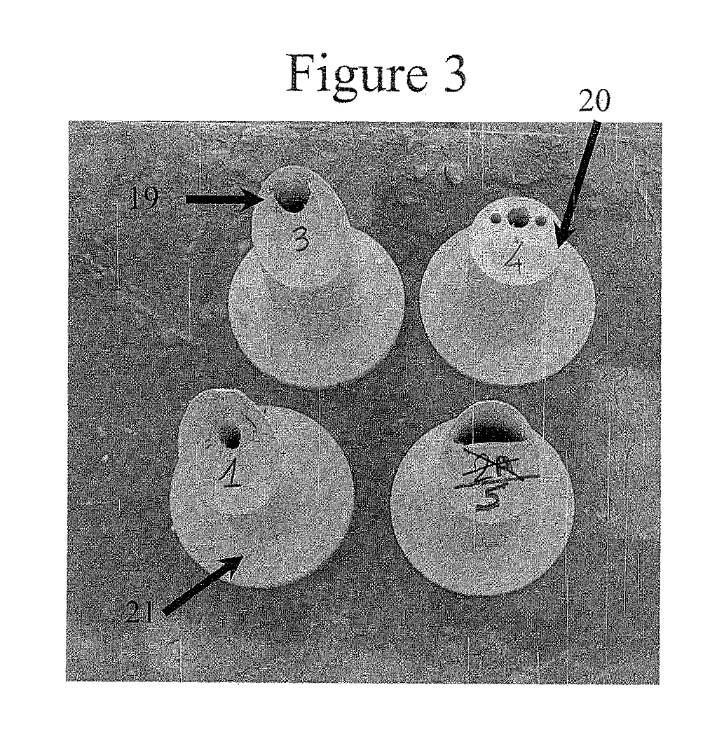

FIG. 3 is a photo of actual nozzles. (19) illustrates the tapered surface of one embodiment of a nozzle. Nozzle (20) illustrates a flat nozzle surface. The nozzle base plate (21) illustrates one of the novelties of the current system. The base plate can fit easily at the inlet of the Benkatina turbine, between the turbine casing and the rest of the piping. It is easy to insert and replace. This is a unique method of inserting a nozzle piece into a pipe, said piece having walls that approximate the internal walls of the pipe. Alternately, the nozzle can be built into the input pipe. The article of manufacture of such an insert is hereby disclosed. The device and method of manufacture of making a separate nozzle to fit inside a pipe are hereby disclosed.

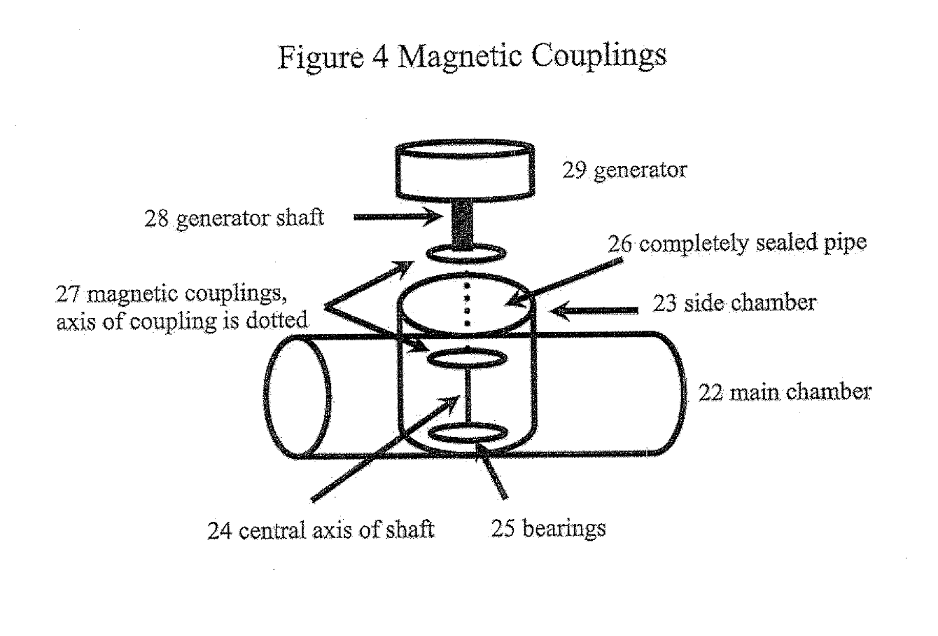

FIG. 4 is a diagram of a magnetic coupling used with a Benkatina turbine. Such a magnetic coupling can be used with impeller turbines as well, particularly those underwater, and other kinds of turbines. The main chamber of the pipe (22) is connected to the side chamber (23) of the Benkatina turbine. The shaft's central axis (24), in the embodiment shown here, is connected to bearings (25) and also to a magnetic coupling (27). The use of magnetic couplings on both sides is herewith introduced. The second half of the coupling (27) is on the other side of a completely sealed casing for the side chamber—or, for other types of turbines as well. The other side of the coupling is connected to the generator shaft (28) and that to the generator (29). This enables a completely closed system in the area of the turbine, so there can be no leakage or contamination from the outside in or the inside out.

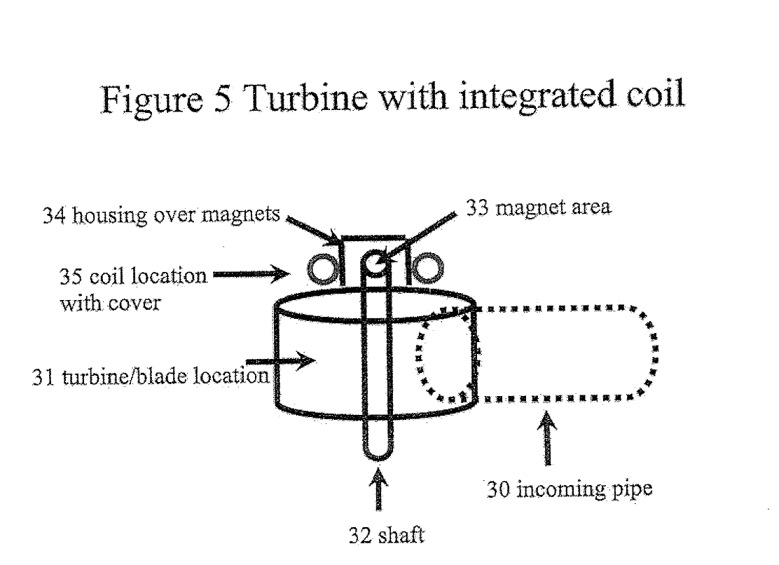

FIG. 5 is a diagram of a Benkatina turbine with a built-in coil. The incoming pipe (30) enters the main chamber where the turbine blades are located (31). The shaft (32) has magnets on at least one end (33). A housing (34) covers these magnets and keeps the system closed. Coils (35) are located nearby outside the pipe.

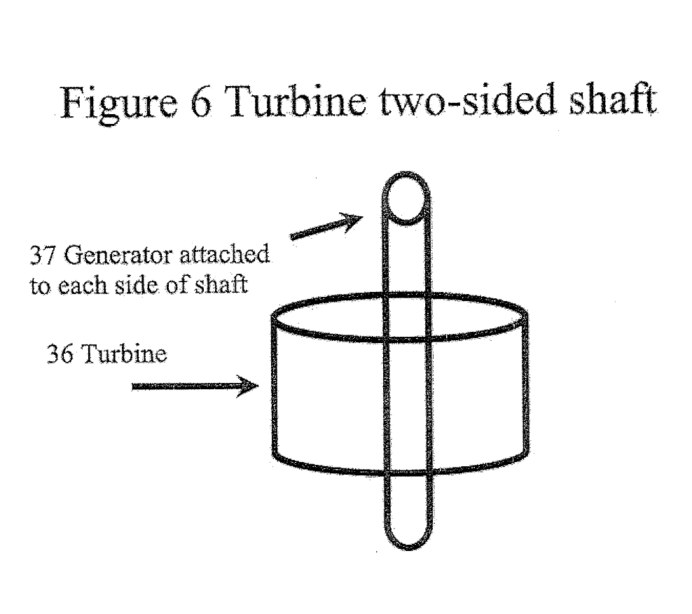

Other means of adjusting the Benkatina turbine for various embodiments are introduced as follows. The use of a stuffing box on at least one side for a mechanical seal is introduced. The shaft of the turbine (36) may be elongated on both sides (37) so that a generator can be placed on both sides, as in FIG. 6. This enables fine-tuning of the power output with easily available generator components.

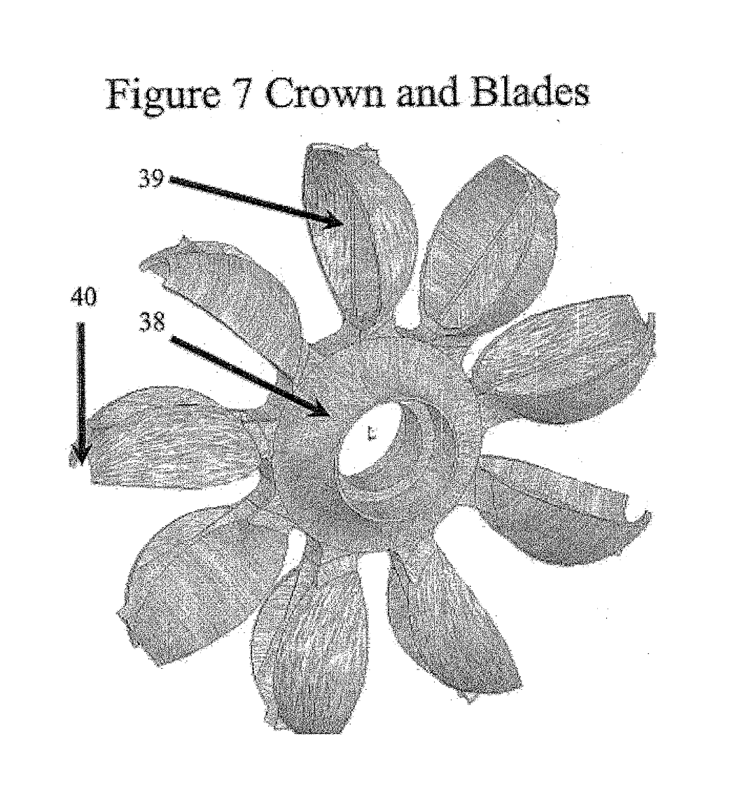

FIG. 7 is a diagram of a crown (38) and blades (39). In one embodiment, a central ridge separates the stream of water into two for better balance. This technique is well known for use in other hydroelectric turbines, but is here introduced in combination with a Benkatina turbine. Cutting off the ends of the blades (40) allows better drainage of water, and is hereby introduced in combination with a Benkatina turbine.

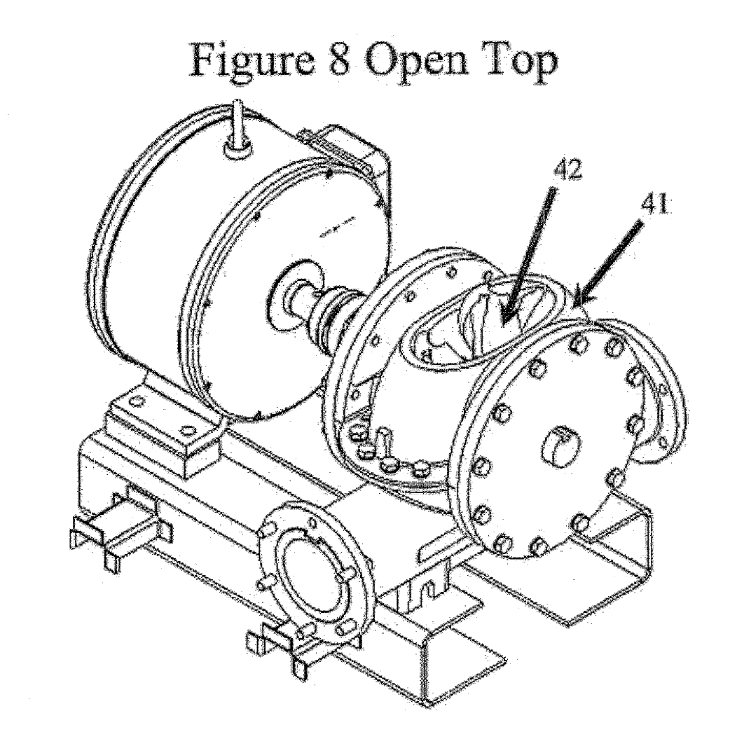

FIG. 8 is a diagram of an open top turbine. The upper casing (41) is cut open to reveal the blades (42), thereby creating an open system and preventing buildup of water in the cups. This is particularly useful for a canal or dam system where the pipe is horizontal.

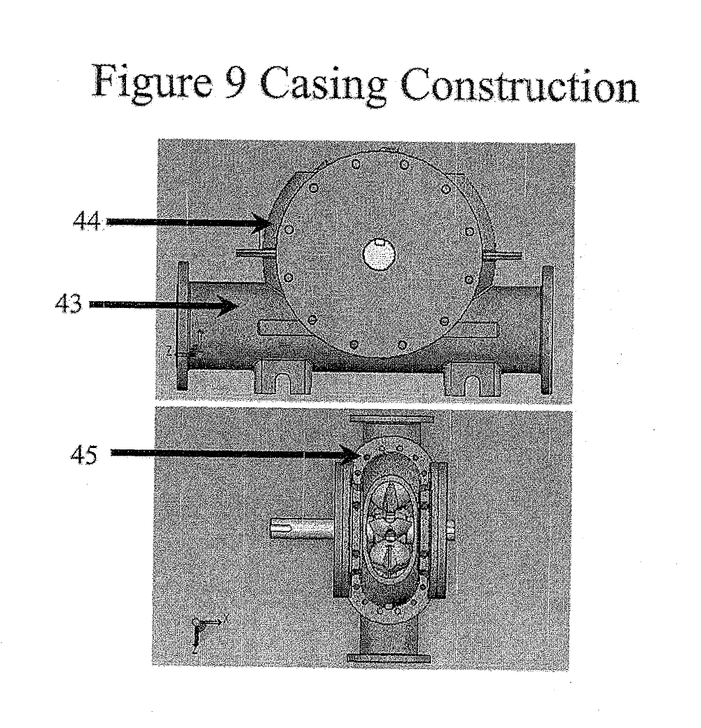

FIG. 9 is a diagram of construction of the casing. The Benkatina turbine's main and side chambers may be manufactured by producing two pieces, in different embodiments through casting or molds. One includes the pipe and extends above it to form a surface peripheral to the pipe (43), and the second (44) forms the rest of the casing of the side chamber. The two parts may then be bolted together along a lip present on each (45). The manufacturing process of making two halves and connecting them is hereby disclosed. The method and device of sealing the turbine with bolts or screws from the outside is hereby disclosed.

The Benkatina pipes and blades may be made of only plastic, such as polystyrene, in the ideal embodiment for applications in corrosive environments.

The blades of a Benkatina Turbine or other turbines can be made of metal covered with fiberglass. This enables them to have the strength of steel or other metal with the benefits of fiberglass on the outside.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a group of solutions to building an in-pipe turbine.

It is now disclosed for the first time a hydroelectric turbine, comprising:

a. a Benkatina turbine,
b. a nozzle piece.

According to another embodiment, the nozzle piece is molded into the pipe.

According to another embodiment, the nozzle piece is inserted into the pipe.

According to another embodiment, the system further comprises:

c. a blade set of the turbine whose location of concavity substantially matches the location of the entry of water from the nozzle piece into the turbine.

According to another embodiment of matching blade sets and nozzle pieces, at least one hole is in the lower half of the nozzle piece. According to another embodiment, it is used in situations of flow where the pipe is filled less than half way at least 50% of the time.

It is now disclosed for the first time a blade for a Benkatina turbine, wherein the periphery of the cup is open.

It is now disclosed for the first time a Benkatina turbine, wherein the circular casing surrounding the turbine periphery extends for more than 180 degrees before it reaches the side of the main chamber piping.

It is now disclosed for the first time a nozzle piece for a Benkatina turbine, wherein the part of the nozzle piece facing the turbine is contoured substantially continuously with the inner wall of the turbine chamber.

It is now disclosed for the first time a nozzle piece for an in-pipe turbine, wherein the hollow section leading into the nozzle is flanged.

It is now disclosed for the first time a turbine operating in a fluid, comprising: a. a set of magnetic couplings connecting the turbine and generator shafts.

According to another embodiment, the turbine is an in-pipe turbine.

It is now disclosed for the first time an in-pipe turbine, wherein the pipe is completely sealed in the vicinity of the turbine, vicinity defined as within one turbine diameter of the turbine edge.

It is now disclosed for the first time an in-pipe turbine, comprising:

a. a turbine,
b. a shaft of said turbine,
c. generator shafts linked to both sides of the turbine shafts.

According to another embodiment, magnetic couplings are used on both sides to provide the link (said link being either physically attached or magnetic).

It is now disclosed for the first time an in-pipe turbine, comprising:

a. a turbine,
b. a shaft of said turbine,
c. at least one mechanical seal connected to said shaft.

It is now disclosed for the first time an in-pipe turbine, comprising:

a. a shaft,
b. a magnet set attached to the end of said shaft,
c. a coil external to the pipe in functional congruity to said magnet set.

It is now disclosed for the first time an in-pipe turbine, comprising:

a. a crown,
b. at least one cup attached to said crown.

It is now disclosed for the first time a method of manufacturing a Benkatina turbine using casting.

It is now disclosed for the first time a Benkatina turbine, wherein a portion of the top casing is open.

It is now disclosed for the first time a method of manufacturing a Benkatina turbine, comprising:

a. providing a first piece that comprises the pipe and a portion of the side chamber,
b. providing a second piece that comprises a portion of the side chamber,
c. connecting the two pieces.

It is now disclosed for the first time a method of manufacturing a Benkatina turbine, comprising:

a. providing the turbine and entry pipe,
b. providing a nozzle for the interior of the entry pipe.

It is now disclosed for the first time a nozzle piece for insertion into a Benkatina turbine, comprising:

a. a base plate attached to the end distal to the turbine.

It is now disclosed for the first time a blade for a Benkatina turbine, comprising:

a. a radially-oriented central ridge in the concave area of the blade.

It is now disclosed for the first time a blade system for a turbine in a liquid, comprising:

a. metal blades coated with fiberglass.

It is now disclosed for the first time a blade for a Benkatina turbine, comprising:

a. a cup whose periphery is cut off in a plane substantially perpendicular to the axis of the cup.

What is claimed is:

1-26. (canceled)

27. A hydroelectric in-pipe turbine, comprising:
a. A nozzle piece, wherein the nozzle piece is inserted into the pipe.

28. The system of claim 27, further comprising:
b. A blade set of the turbine whose location of concavity substantially matches the location of the entry of water from the nozzle piece into the turbine, wherein at least one hole is in the lower half of the nozzle piece, and it is used in situations of flow where the pipe is filled less than half way at least 50% of the time.

29. A nozzle piece for an in-pipe turbine, wherein the part of the nozzle piece facing the turbine is contoured substantially continuously with the inner wall of the turbine chamber.

30. A turbine operating in a fluid, comprising:
a. A set of magnetic couplings connecting the turbine and generator shafts.

31. The turbine of claim 30, wherein the turbine is an in-pipe turbine.

32. An in-pipe turbine, comprising:
a. A turbine,
b. A shaft of said turbine,
c. Generator shafts operationally linked to both sides of the turbine shafts.

33. An in-pipe turbine, wherein the circular casing surrounding the turbine periphery extends for more than 180 degrees.

34. An in-pipe turbine, comprising:
a. A shaft,
b. A magnet set attached to the end of said shaft,
c. A coil external to the pipe in functional congruity to said magnet set.

35. A method of manufacturing an in-pipe turbine using casting.

36. An in-pipe turbine, wherein a portion of the top casing is open.

37. A method of manufacturing an in-pipe turbine, comprising:
a. Providing a first piece that comprises the pipe and a portion of the side chamber,
b. Providing a second piece that comprises a portion of the side chamber,
c. Connecting the two pieces.

38. A nozzle piece for insertion into an in-pipe turbine, comprising:
a. A base plate attached to the end distal to the turbine.

39. A blade for an in-pipe turbine, comprising:
a. A radially-oriented central ridge in the concave area of the blade.

40. A blade system for a turbine in a liquid, comprising:
a. Metal blades coated with fiberglass.

41. A blade for a Benkatina turbine, comprising:
a. A cup whose periphery is cut off in a plane substantially perpendicular to the axis of the cup.
